(19) United States
(12) Patent Application Publication
(10) Pub. No.: US 2007/0012352 A1
(43) Pub. Date: Jan. 18, 2007

(54) Photovoltaic Modules Having Improved Back Sheet

(75) Inventors: John H. Wohlgemuth, Ijamsville, MD (US); Daniel W. Cunningham, Mount Airy, MD (US); Jay R. Shaner, Frederick, MD (US); Haibin Yu, Frederick, MD (US)

Correspondence Address: CAROL WILSON;BP AMERICA INC., MAIL CODE 5 EAST, 4101 WINFIELD ROAD, WARRENVILLE, IL, 60555, US

(73) Assignee: BP CORPORATION NORTH AMERICA INC., Warrenville, IL (US)

(21) Appl. No.: 11/456,686

(22) Filed: Jul. 11, 2006

Related U.S. Application Data
(60) Provisional application No. 60/700,206, filed on Jul. 18, 2005.

(51) Int. Cl. H02N 6/00

(52) U.S. Cl. 136/251

(57) ABSTRACT

A photovoltaic module comprising a first superstrate, a back sheet, a photovoltaic cell or a plurality of photovoltaic cells, each photovoltaic cell encapsulated and positioned between the superstrate and the back sheet, where the back sheet comprises a polyester material.

This application claims the benefit of U.S. Provisional Patent Application 60/700,206 filed on Jul. 18, 2005.

### FIELD OF THE INVENTION

The present invention relates to improved photovoltaic modules. More particularly, the present invention relates to photovoltaic modules containing photovoltaic cells wherein the back sheet used to form the photovoltaic module comprises a polyester material. This invention also relates to methods for making such improved photovoltaic modules.

### BACKGROUND OF THE INVENTION

Photovoltaic devices convert light energy, particularly solar energy, into electrical energy. Photovoltaically generated electrical energy can be used for all the same purposes that electricity generated by batteries or electricity obtained from established electrical power grids can be used, but is a renewable form of electrical energy. One type of photovoltaic device is known as a photovoltaic module, also referred to as a solar module. These modules contain one or, more typically and preferably, a plurality of photovoltaic cells, also referred to as solar cells, positioned and sealed between a superstrate sheet, such as a sheet of clear glass or clear polymeric material, and a back sheet, such as a sheet of polymeric material. The sealant, typically referred to as an encapsulant, serves to adhere the superstrate sheet to the back sheet with the photovoltaic cells sealed in the encapsulant between the superstrate and back sheets. The photovoltaic cells can be made from wafers of silicon or other suitable semiconductor material, or they can be a thin film-type of cell typically deposited on the superstrate or back sheet by one of the various processes and methods known to those of skill in the art of manufacturing thin film-type photovoltaic cells. One of the more common types of photovoltaic modules contains a plurality of individual photovoltaic cells made from silicon wafers. Such individual photovoltaic cells are typically made of either monocrystalline or multicrystalline silicon wafers and, typically, a number of such individual cells are electrically linked within the module in a desired arrangement to achieve a module having a desired electrical output upon exposure to the sun.

In most applications, photovoltaic modules are mounted in an outside location such as on a rooftop or supporting structure designed to support one or more photovoltaic modules. Thus, the sealed photovoltaic modules must resist moisture penetration when exposed to normal outdoor elements (e.g., humid air, rain, snow, ice). Since photovoltaic modules are expected to perform over an extended time period, such as 20 to 25 years, the ability to resist such moisture penetration should last for such extended time periods. If moisture penetrates into the modules and to the photovoltaic cells therein, the moisture will not only have an adverse affect on the appearance of the module but, more importantly, will ultimately result in the decreased performance or, possibly, total failure of the module. Therefore, it is important for the back sheet to form a good seal to the superstrate sheet and be made of a material that resists moisture penetration.

Photovoltaic modules must be able to pass stringent electrical safety tests such as the UL 1703 or IEC 61730. The back sheet should, therefore, be made of a material that has a sufficiently high dielectric breakdown voltage. The back sheet should be made of a material that is not difficult to manipulate and apply during the lamination process that may be used to form the photovoltaic module. Also, since photovoltaic modules are typically mounted in a manner such that they are in view, they need to be aesthetically appealing, as well. Therefore, the appearance of the back sheet should not detract from the appearance of the photovoltaic module.

In prior modules, the back sheet is made of a commercially available polyvinylfluoride (PVF) film material or of multi-layers of PVF and polyester. PVF back sheets are susceptible to scratching and tearing, and extra care must be taken during the process of manufacturing photovoltaic modules using back sheets made of PVF in order to avoid such scratching and tearing. Such scratching and tearing can also occur with such modules if the proper care is not observed when mounting the modules. While PVF sheets resist moisture penetration, a material having less moisture penetration would increase the life of the photovoltaic module. Additionally, it would be desirable to have a back sheet that has a higher dielectric breakdown voltage than PVF. While a back sheet with multiple layers of PVF and polyester can have a high dielectric breakdown voltage and can resist moisture penetration, such multiple-layer materials are too expensive for use in competitively priced photovoltaic modules. In these multiple-layer materials where one layer is made of polyester, the other layers are required to provide the necessary performance characteristics that the polyester layer lacks.

Thus, the art needs a photovoltaic module having a back sheet that is aesthetically appealing, resists scratching and tearing, has a low moisture penetration and has a high dielectric breakdown voltage and, preferably, where such back sheet is a single layer. Additionally, the art needs a process for forming photovoltaic modules using such a back sheet where the back sheet is easy to install. The present invention provides for such photovoltaic module and process.

### SUMMARY OF THE INVENTION

This invention is a photovoltaic module comprising a transparent superstrate sheet, a back sheet comprising a polyester, a photovoltaic cell or a plurality of photovoltaic cells embedded in an encapsulant and positioned between the superstrate sheet and the back sheet.

This invention is also a process for manufacturing such photovoltaic modules. The photovoltaic modules of this invention are useful for converting sunlight into electrical energy.

### BRIEF DESCRIPTION OF THE INVENTION

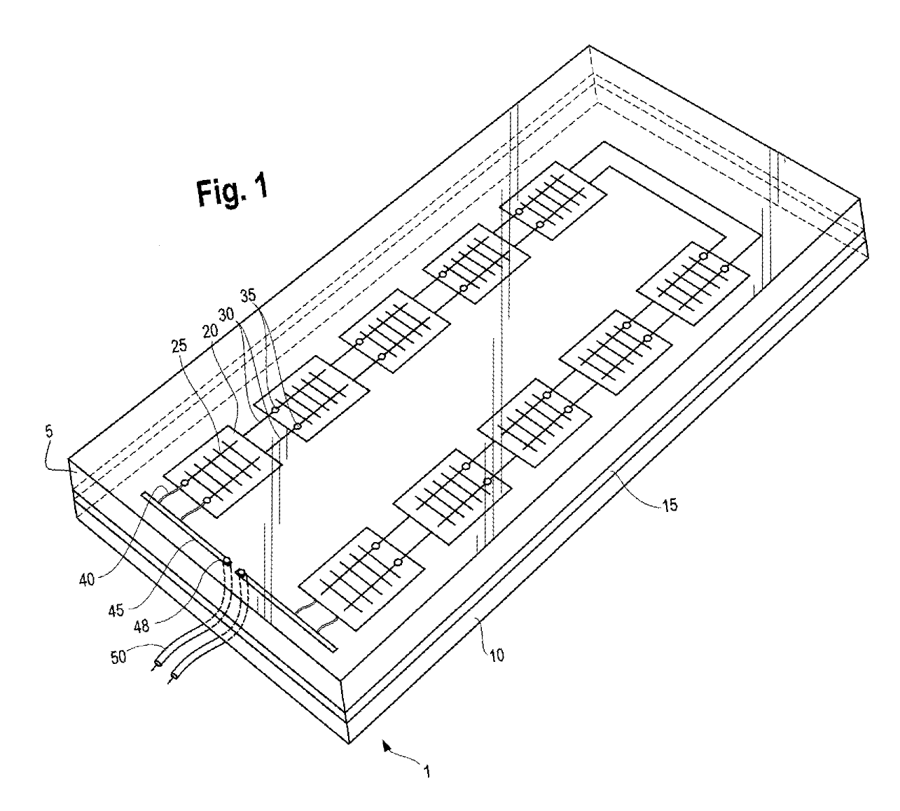

FIG. 1 is drawing of one embodiment of the photovoltaic module of this invention having a back sheet comprising a polyester.

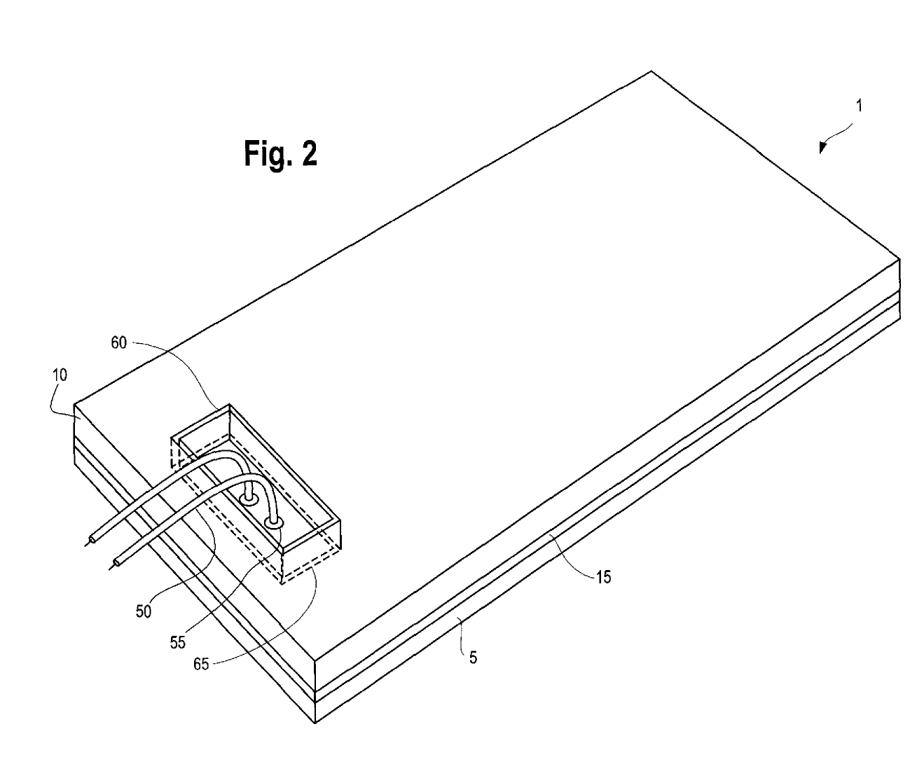

FIG. 2 is a drawing of the underside of the photovoltaic module shown in FIG. 1.

### DETAILED DESCRIPTION OF THE INVENTION

This invention is a photovoltaic module comprising a superstrate sheet, a back sheet comprising a polyester material, a photovoltaic cell or a plurality of photovoltaic cells embedded in an encapsulant, where each photovoltaic cell is positioned between the superstrate sheet and the back sheet.

The superstrate sheet can be made of any suitable material that is transparent to solar radiation, particularly to solar radiation in the visible range. The superstrate sheet is preferably a flat sheet. For example, the superstrate sheet can be made of glass or a polymeric material. Preferably, it is made of clear, tempered or heat strengthened glass. The superstrate sheet can be of any convenient size and thickness. For example, it can be about 1 to about 20 square feet and can, for example, be rectangular or square in shape. The thickness of the superstrate is variable and will, in general, be selected in view of the application of the module. If, for example, the module uses glass as the superstrate sheet, the glass can range in thickness from about 3.2 mm to about 5 mm.

The photovoltaic cells used in the photovoltaic modules of this invention can be any suitable photovoltaic cell. For example, they can be cells made from monocrystalline or polycrystalline (multicrystalline) silicon wafers, or wafers made from other suitable semiconductor materials. They can be thin film photovoltaic cells such as, for example, cells made from amorphous silicon or from cadmium telluride and cadmium sulfide. Methods for manufacturing photovoltaic cells are well-known in the art.

In the modules of this invention, the preferred photovoltaic cells are made from monocrystalline or multicrystalline wafers. These cells can be any shape, but are typically circular, square, rectangular or pseudo-square in shape. By “pseudo-square” is meant a predominantly square shape usually with rounded corners. For example, a monocrystalline or multicrystalline photovoltaic cell useful in this invention can be about 50 microns thick to about 400 microns thick. If circular, it can have a diameter of about 100 to about 200 millimeters. If rectangular, square or pseudo square, it can have sides of about 100 millimeters to about 210 millimeters and where, for the pseudo-square wafers, the rounded corners can have a diameter of about 127 to about 178 millimeters.

In one type of photovoltaic module in accordance with this invention a plurality of photovoltaic cells made from silicon monocrystalline or multicrystalline wafers are connected in series or other desirable arrangement using suitable electrical conduits such as wires or electrically conducting metal strips. The individual photovoltaic cells are arranged and electrically connected to achieve a desired output voltage of the module when the module is exposed to the sun. The number of such cells can vary, but there may be about 36 to about 72 such cells in a module.

The back sheet for the photovoltaic module of this invention comprises a polyester material. Polyester materials are well known. A polyester material is a polymer that can, for example, be made by chemically reacting one or more polycarboxylic acids, or equivalent thereof, such as one or more dicarboxylic acids or equivalent thereof, with one or more polyols, such as one or more glycols, to form a high molecular weight polyester polymer. The carboxylic acids used can be aromatic carboxylic acids such as one or more of terephthalic acid, isophthalic acid, or naphthalene dicarboxylic acid. The polyol can be one or more of ethylene glycol, propylene glycol, or a butylene glycol. Specific polyesters are polyethylene terephthalate (also known as PET), polybutylene terepthhalate (also known as PBT) and polyethylene naphthalate (also known as PEN). Polyesters, as mentioned above, can be made from mixtures of polycarboxylic acids and from mixtures of polyols. The polyester material can also be a blend of one or more different polyesters. The polyester material can also contain additives blended therein such as one or more of a colorant or pigment, plasticizer, flame retardant, filler, antioxidant, ultraviolet (UV) stabilizer, or other additive. Preferably, the back sheet in the photovoltaic module of this invention is a polyester material.

The back sheet comprising a polyester material useful in the photovoltaic module of this invention is, preferably, shaped and of the same or about the same size, as the superstrate sheet and, preferably, has a thickness of about 0.002 inch to about 0.007 inch. Preferably it has a water vapor transmission rate that is less than about 10 grams/meters²/day at 37.8° C. as measured by the ASTM E96 procedure. Preferably, the back sheet comprising one or more polyester materials useful in the photovoltaic module of this invention has a dielectric breakdown voltage that is greater than about 12,000 volts (V) measured using a 0.002 inch thick sheet and preferably is greater than about 22,500 V measured using a 0.005 inch thick or thicker sheet, where the dielectric breakdown voltage is measured by the ASTM D149 procedure. Preferably, the back sheet comprising a polyester material useful in the photovoltaic module of this invention has a tensile strength of at least about 18,800 pounds per square inch (psi) as measured by ASTM D882. In the preferred photovoltaic module of this invention, the back sheet comprising a polyester material is a single layer.

Preferably, the back sheet comprising a polyester material does not significantly degrade as a result of exposure to ultraviolet radiation (UV), such as UV produced by the sun. Thus, the preferred back sheet in accordance with the modules of this invention preferably has a UV resistance so that after exposure to UV for an extended period of time the back sheet does not significantly degrade. Such resistance to degradation by UV exposure can be evaluated by a UV exposure simulation test. The UV exposure simulation test is the same as test procedure ASTM G155-1 except that a UV irradiance level of 0.7 Watts/meter² (W/m²) measured at 340 nanometers (nm) is used instead of 0.35 W/m², the irradiance is continuous rather than cycled, and the sample temperature is 90° C. not 63° C. In the UV exposure simulation test, the back sheet of the module is exposed to UV in air in an Atlas Weather-Ometer using a xenon arc lamp with 2 borosilicate glass filters using the same filters and filter arrangement as described in test procedure ASTM G155-1. A UV dose rate of 0.7 W/m² measured at 340 nm is used with a sample temperature of 90° C. and at an ambient humidity of 50%. Since large photovoltaic modules do not fit within the Weather-Ometer testing device, smaller, 6 inch square test modules are used for the UV exposure simulation test. In one test module, the module contains a functioning photovoltaic cell, in another test module a photovoltaic cell is not present. In the UV exposure simulation test, test modules containing the photovoltaic cell are exposed directly to the UV at the test conditions described above for 500 continuous hours where the back sheet of the test module faces the xenon lamp. Test modules that do not contain the photovoltaic cell are exposed directly to the UV at the test conditions described above for 2000 continuous hours where the superstrate sheet of the test module faces the xenon lamp. The xenon lamp is held perpendicular to the test module so that the distance from the front of the lamp to the surface of the test module being irradiated is between 1 and 2 feet. The actual distance is adjusted so that the surface of the test module facing the xenon lamp receives 0.7 W/m² UV at 340 nm. After such treatment, the module is evaluated to determine if the back sheet has significantly degraded. One preferred method to determine if significant degradation to the back sheet has occurred as a result of the UV exposure simulation test is to test the test module having the photovoltaic cell in the Wet Leakage Current Test in accordance with the procedure in IEC 61215. If the module passes the Wet Leakage Current Test at a voltage of 1000 V, the back sheet has not significantly degraded. Preferably, the modules of this invention having a back sheet comprising a polyester material, and more preferably where the back sheet is a single layer, pass the Wet Current Leakage Test at a voltage of 1000 V after the UV exposure simulation test. Another preferred method to determine if significant degradation has occurred as a result of the UV exposure simulation test is to use the pull test. In the pull test the back sheet is pulled using a pull tester at a low pull strength (1 pound/inch), and if the back sheet has undergone significant degradation, the back sheet can be pulled away with a low pull strength (1 lb/in) and can be separated from underlying encapsulant material by such pulling. If the back sheet can be pulled away by the pull test, the module fails the pull test and significant degradation to the back sheet has occurred. If it cannot be pulled away by the pull test, the module passes the pull test. Preferably, the modules of this invention having a back sheet comprising a polyester material, and more preferably where the back sheet is a single layer, pass the pull test after the UV exposure simulation test.

The back sheet of the photovoltaic module of this invention comprising a polyester material does not significantly degrade by exposure to humidity. Some polyester sheet materials break down or degrade after exposure to high humidity for an extended period of time. Thus, the preferred back sheet in accordance with the photovoltaic modules of this invention retains its mechanical strength after exposure to high humidity conditions for an extended period of time. Such resistance to degradation by high humidity can be evaluated by a humidity simulation test. In this humidity simulation test, the photovoltaic module is exposed to air having a relative humidity of 85% and at a temperature of 85° C. After such treatment, the back sheet is examined to determine if it has undergone significant degradation. One preferred method to determine if significant degradation has occurred is to use the pull test described above. If the back sheet has undergone significant degradation, the back sheet can be pulled away with a low pull strength (1 lb/in) and can be separated from underlying encapsulant material by such pulling. Another method to determine if significant degradation has occurred due to exposure to high humidity for extended periods is to perform the Wet Leakage Current Test. If the photovoltaic module passes the Wet Leakage Current Test at a voltage of 1,000 V, the back sheet has not significantly degraded. In the preferred photovoltaic module of this invention having the back sheet comprising a polyester material, the back sheet does not undergo significant degradation after 1,500 hours of the humidity simulation test.

In the preferred embodiment of this invention where the back sheet of the photovoltaic module comprising a polyester material is a single layer, the back sheet comprising a polyester does not undergo significant degradation after the humidity simulation test for 1,500 hours. Preferably, the modules of this invention having a back sheet comprising a polyester material, and more preferably where the back sheet is a single layer, pass the Wet Current Leakage Test at a voltage of 1,000 V after the humidity simulation test for 1,500 hours. This shows that the back sheet comprising a polyester continues to maintain desirable dielectric properties after the long term exposure to humidity. Preferably, the modules of this invention having a back sheet comprising a polyester material, and more preferably where the back sheet is a single layer, pass the pull test after the humidity simulation test for 1,500 hours.

In the preferred photovoltaic modules of this invention having a back sheet comprising a polyester material, the module passes the Impulse Voltage Test at a test voltage of 8,000 V. The Impulse Voltage Test is described in procedure IEC 61730-2. The preferred photovoltaic module of this invention having a back sheet comprising a polyester material, and preferably were the back sheet is a single layer, passes the Impulse Voltage Test at a test voltage of 8,000 V after the high humidity simulation test for 1,500 hours. The preferred photovoltaic module of this invention having a back sheet comprising a polyester material, and preferably were the back sheet is a single layer, passes the Impulse Voltage Test at a test voltage of 8,000 V after the UV exposure simulation test.

Preferably the back sheet comprising a polyester material in the photovoltaic module of this invention, and most preferably when the back sheet is a single layer, has a silicone primer applied to the side of the sheet that faces the module, to the side of the sheet that faces away from the module and, most preferably to both sides of the sheet. A suitable silicone primer is Dow Corning Z6040.

A suitable polyester sheet useful as a back sheet for the module of this invention is W270 available from Mitsubishi Polymer Film, LLC. A suitable thickness for such sheet is about 0.002 inch to about 0.007 inch. Another suitable polyester sheet useful as a back sheet for the module of this invention is WSAC polyester also available from Mitsubishi Polymer Film, LLC. A suitable thickness for such a sheet is about 0.002 inch to about 0.007 inch. The WSAC polyester sheet has a silicone primer on each side of the sheet. If the back sheet comprising a polyester does not have a primer, a suitable silicone primer such as Dow Corning Z6040 can be applied to both sides of the polyester sheet, preferably before the sheet is used to construct the module.

The back sheet can comprise one or more layers comprising a polyester, preferably where at least such one layer comprising a polyester material has one or more and preferably all of the following properties: a thickness of about 0.002 inch to about 0.007 inch, a water vapor transmission rate that is less than about 10 grams/meters²/day at 37.8° C. as measured by the ASTM E96 procedure, a dielectric breakdown voltage that is at least, and preferably, greater than about 12,000 V measured using a 0.002 inch thick layer and preferably greater than about 22,500 V measured using a 0.005 inch thick or thicker layer, where the dielectric breakdown voltage is measured by the ASTM D149 procedure, a tensile strength of at least about 18,800 psi as measured by the ASTM D882 procedure. The back sheet can comprise one or more layers comprising a polyester material and one or more layers of other materials such as, for example, a layer of PVF, a polycarbonate, or another polyester, preferably where at least one such layer comprising a polyester material has one or more, and preferably all, of the following properties: a thickness of about 0.002 inch to about 0.007 inch, a water vapor transmission rate that is less than about 10 grams/meters²/day at 37.8° C. as measured by the ASTM E96 procedure, a dielectric breakdown voltage that is at least, and preferably, greater than about 12,000 V measured using a 0.002 inch thick layer and preferably greater that about 22,500 V measured using a 0.005 inch thick or thicker layer, where the dielectric breakdown voltage is measured by the ASTM D149 procedure, and a tensile strength of at least about 18,800 psi as measured by the ASTM D882 procedure.

Preferably, the back sheet in the photovoltaic modules of this invention is a single layer comprising a polyester material and preferably where such layer has one or more, and more preferably all, of the following properties: a thickness of about 0.002 inch to about 0.007 inch, a water vapor transmission rate that is less than about 10 grams/meters²/day at 37.8° C. as measured by the ASTM E96 procedure, a dielectric breakdown voltage that is at least, and preferably, greater than about 12,000 V measured using a 0.002 inch thick layer and preferably greater than about 22,500 V measured using a 0.005 inch thick or thicker layer, where the dielectric breakdown voltage is measured by the ASTM D149 procedure, and a tensile strength of at least about 18,800 psi as measured by the ASTM D882 procedure. Preferably, in the photovoltaic modules of this invention having a back sheet comprising a polyester that is a single layer, the back sheet does not undergo significant degradation after the high humidity simulation test run for 1500 hours and does not undergo significant degradation after the UV exposure simulation test, and after such UV exposure simulation test the photovoltaic module having such single layer back sheet passes the Wet Leakage Current Test at a voltage of 1,000 V, and after such high humidity simulation test the photovoltaic module having such single layer back sheet passes the Wet Leakage Current Test at a voltage of 1,000 V.

In a typical procedure for constructing a module in accordance with this invention, the electrically connected photovoltaic cells are positioned adjacent to or on the superstrate sheet or attached to it using an encapsulant such as a sheet of ethylene vinyl acetate (EVA) or other suitable encapsulant, and an encapsulant material such as a sheet of ethylene vinyl acetate (EVA) or other suitable encapsulant is positioned between the photovoltaic cells and a back sheet. The superstrate sheet, photovoltaic cells and back sheet are then pressed together, i.e., laminated, to form a unit sealed by the encapsulant material and comprising a superstrate sheet, a plurality of electrically connected cells and a back sheet. The lamination process is typically conducted at an elevated temperature and under reduced pressure. The temperature for such lamination should be a temperature that is about or higher than the cure temperature of the encapsulant used to seal the superstrate sheet to the back sheet. For example, when the encapsulant is a sheet of EVA, this temperature should be at least about 130° C. The use of a reduced pressure during the lamination process reduces or eliminates the formation of unwanted bubbles in the laminate. In order to improve the adhesion of the encapsulant, such as a sheet of EVA, a primer material can be added to the surfaces of the back sheet, incorporated in the encapsulant, or both. Such primers are for example organo-reactive silanes such as Dow Corning Z6020, Z6030, Z6040, Z6076 or Z6094.

The back sheet can have openings through which pass electrical connectors, such as insulated wires or electrical cables, that connect to the photovoltaic cells within the laminated module. When the module is in operation these output cables are used to connect the module to the system or device that will utilize the electrical current generated by the module. The openings in the back sheet through which such output cables pass can be, and preferably are, covered by a junction box. The junction box is suitably made of an electrically non-conducting polymeric material. Preferably the junction box is attached to the back sheet on the underside of the module using an adhesive, and the junction box is typically filled with a sealant so that moisture is prevented from entering the laminate through the openings in the back sheet for the output cables. The junction box filled with sealant also serves to anchor the output cables so that they can be manipulated without causing damage to the finished module when the finished module is mounted for its intended application.

The invention will now be described with reference to the figures, which show certain embodiments of the invention, but are not meant in any way to limit the scope of the invention.

FIG. 1 shows one embodiment of the photovoltaic module of this invention. The photovoltaic module 1 in FIG. 1 has a superstrate sheet 5, preferably made of glass or other suitable transparent material, and polyester back sheet 10. Between superstrate sheet 5 and back sheet 10 is sandwiched a plurality of photovoltaic cells 20 electrically connected in series, a shown in FIG. 1. Between the superstrate sheet 5 and the back sheet 10 is a sheet of ethylene vinyl acetate (EVA) 15 that seals the superstrate sheet 5 to the back sheet 10 with the photovoltaic cells 20 sealed in between. For clarity, in FIG. 1, only one photovoltaic cell is designated by a number 20. These photovoltaic cells can be any type of photovoltaic cell such as cells made from multicrystalline or monocrystalline silicon wafers. Each cell, as shown in the FIG. 1, has a grid-type, front electrical contact 25. (For clarity, only one grid-type front contact is labeled in the figure.) Sunlight enters through superstrate sheet 5 and impinges on the front side of the photovoltaic cells 20. Cells 20 are electrically connected in series by wires 30. Wires 30 are attached to the back contact on the back side of photovoltaic cells 20 (back side of photovoltaic cells not shown) and to solder contact points 35 on front side of photovoltaic cells 20 to form the series connected cells. (For clarity, only one set of wires 30 and one set of solder contact points 35 on front side of photovoltaic cells are labeled in FIG. 1.) The wires are suitably flat, tinned-copper leads, electrical wires or other suitable electrical conduits.

The first and last photovoltaic cell in the series-connected cells shown in the module of FIG. 1 are connected by the electrical connection wires of the end cells 40 to bus bars 45. Bus bars 45 are also electrical conduits, and can be, for example, wires or flat electrical leads. Bus bars 45 end with solder points 48. Electrical cables 50 are soldered to bus bars 45 at solder points 48. Electrical cables extend out the underside of module 1 through holes in back sheet 10 (not shown in FIG. 1). Electrical cables 50 are used to electrically connect module 1 to the system or device that will use the electrical current generated by photovoltaic module 1. (For clarity only one electrical conduit 40, one bus bar 45, one solder point 48 and one cable 50 are labeled in FIG. 1.)

In FIG. 1, back sheet 10 is a sheet of WSAC polyester having a thickness of 0.002 inch. It has a water vapor transmission rate that is less than about 10 grams/m²/day at 37.8° C. as measured by the ASTM E96 procedure, and a dielectric breakdown voltage that is greater than about 12000 V as measured by the ASTM D149 procedure.

FIG. 2 shows the underside of the photovoltaic module shown in FIG. 1. In FIG. 2, the elements that are the same as in FIG. 1 are numbered the same.

FIG. 2 shows electrical cables 50 extending from openings 55 in back sheet 10. Around openings 55 is junction box 65. Junction box 65 is, for clarity, shown without a cover. In its finished form, junction box 60 would have a cover and cables 50 would extend through openings in such cover or through one or more of the sides of the junction box. Junction box 60 would also be filled with a suitable sealant such as a silicone or an epoxy. The sealant in the junction box seals the openings 55 and also serves to anchor cables 50 so that they do not disrupt the seal around opening 55 when the cables are manipulated. Bottom surface 65 of junction box 60 is preferably attached to polyester back sheet 10 using an adhesive. We determined that adhesives having a neutral rather than an acidic curing system are preferred for adhering a junction box to a back sheet comprising a polyester material. For example, we discovered that adhesives having an alkoxy-, amine-, enoxy- or oxime-type cure system form a moisture resistant lasting bond between the junction box and the polyester sheet. Oxime-cured adhesives such as Dow Corning 737 and enoxy-cured adhesives such as Shin Etsu KE347TUV are suitable. Amine-cured adhesives such as Dow Corning RTV 790 and alkoxy-cured adhesives such as Dow Corning RTV 739 are also suitable adhesives for adhering the junction box to the back sheet comprising a polyester material.

Although the invention has been described with respect to photovoltaic modules containing photovoltaic cells made from silicon wafers, it is to be understood, as mentioned above, that the invention is not limited to such photovoltaic cells. The photovoltaic cells can be of any type. For example, they can be thin film-type photovoltaic cells such as thin film amorphous silicon cells or CdS/CdTe cells. Such photovoltaic cells are known in the art and can be deposited onto a suitable superstrate material such as glass or metal by known methods. For example, methods for forming amorphous silicon cells which can be used in this invention are set forth in U.S. Pat. Nos. 4,064,521 and 4,292,092, UK Patent Application 9916531.8 (Publication No. 2339963, Feb. 9, 2000) all of which are incorporated herein by reference.

This invention is also a process of making a photovoltaic module comprising sealing between a superstrate sheet and a back sheet at least one photovoltaic cell and preferably a plurality of electrically connected photovoltaic cells, where the back sheet comprises a polyester material as described herein above.

It is to be understood that only certain embodiments of the invention have been described and set forth herein. Alternative embodiments and various modifications will be apparent from the above description to those of skill in the art. These and other alternatives are considered equivalents and within the spirit and scope of the invention.

### EXAMPLE

A photovoltaic module was made by laminating 36 series-connected photovoltaic cells between a sheet of ⅛ inch thick clear tempered glass approximately 60 inches long and approximately 26 inch wide as the superstrate sheet, and a single layer of WSAC polyester material 0.002 inch thick, and of approximately the same length and width as the superstrate, as the back sheet. The lamination was accomplished by preparing a layered structure having the superstrate sheet, followed by a sheet of clear EVA with added primer, followed by the 36 series-connected photovoltaic cells having their photovoltaically active surfaces positioned facing the superstrate sheet, followed by a sheet of fiberglass reinforced EVA (also with an added primer to improve adhesion to the polyester), and, lastly, the WSAC polyester back sheet. The layered structure also included within the appropriate bus bars for making the required electrical circuits and connections. The layered structure was placed into a lamination press having a platen heated to 150° C. After resting on the platen for about 3-4 minutes to heat the layered structure under vacuum, the lamination press was activated and the layered structure was pressed together using 1 atmosphere of pressure for a time sufficient to permit the EVA to encapsulate the photovoltaic cells, cross-link and form a sealed photovoltaic module.

A photovoltaic module made in such manner having the WSAC single layer back sheet was subjected to the humidity simulation test as described herein above for 1500 hours. The back sheet did not undergo significant degradation after such testing and the module passed the Wet Leakage Current Test, as described above, at a voltage of 1,000 V. A 6 inch square test module containing a photovoltaic cell and having a WSAC single layer back sheet was tested in the UV exposure simulation test a described above and the back sheet did not undergo significant degradation after such testing, and the module passed the Wet Leakage Current Test, as described above, at a voltage of 1,000 V.

This extreme testing showed that a photovoltaic module having a back sheet comprising a polyester in accordance with this invention has excellent resistance to environmental conditions of high humidity and UV exposure.

U.S. Provisional Patent Application 60/700,206 filed on Jul. 18, 2005, is incorporated herein by reference in its entirety.

What is claimed is:

1. A photovoltaic module comprising:
a superstrate sheet,
a back sheet comprising a polyester material that does not significantly degrade after prolonged exposure to UV radiation or high humidity,
a photovoltaic cell or a plurality of photovoltaic cells, each positioned between the superstrate and the back sheet.

2. The photovoltaic module of claim 1 wherein the back sheet is a single layer comprising a polyester material.

3. The photovoltaic module of claim 1 wherein the back sheet comprises at least one layer comprising a polyester material that has a thickness of about 0.002 inch to about 0.007 inch.

4. The photovoltaic module of claim 1 wherein the back sheet comprises at least one layer comprising a polyester material that has a water vapor transmission rate that is less than about grams/meters²/day at 37.8° C. as measured by the ASTM E96 procedure.

5. The photovoltaic module of claim 1 wherein the back sheet comprises at least one layer comprising a polyester material that has a dielectric breakdown voltage greater than about 12,000 V measured by the ASTM D149 procedure for a 0.002 inch thick layer.

6. The photovoltaic module of claim 1 wherein the back sheet comprises at least one layer comprising a polyester material that has a tensile strength of at least about 18,000 psi as measured by the ASTM D882 procedure.

7. The photovoltaic module of claim 1 wherein the back sheet comprises at least one layer comprising a polyester material that has a water vapor transmission rate that is less than about 10 grams/meters²/day at 37.8° C. as measured by the ASTM E96 procedure, a dielectric breakdown voltage greater than about 12,000 V measured by the ASTM D149 procedure for a 0.002 inch thick sheet, and a tensile strength of at least about 18,000 psi as measured by the ASTM D882 procedure.

8. The photovoltaic module of claim 1 wherein the back sheet is a single layer comprising a polyester material where such layer has a water vapor transmission rate that is less than about 10 grams/meters2/day at 37.8° C. as measured by the ASTM E96 procedure, a dielectric breakdown voltage greater than about 12,000 V measured by the ASTM D149 procedure for a 0.002 inch layer, and a tensile strength of at least about 18,000 psi as measured by the ASTM D882 procedure.

9. The photovoltaic module of claim 1 further comprising an encapsulant between the superstrate sheet and the back sheet.

10. The photovoltaic module of claim 9 further comprising a primer material added to the encapsulant.

11. The photovoltaic module of claim 10 wherein the primer material comprises an organo-reactive silane-type of primer.

12. The photovoltaic module of claim 1 having an underside and further comprising a junction box attached to the back sheet on the underside of the photovoltaic module.

13. The photovoltaic module of claim 12 wherein the junction box is attached to the back sheet by an adhesive selected from one or more of an oxime-cured adhesive, and amine-cured adhesive, an enoxy-cured adhesive or an alkoxy-cured adhesive.

14. The photovoltaic module of claim 1 that passes Impulse Voltage Testing at a voltage of 8,000 V as measured by the procedure in IEC 61730-2.

15. The photovoltaic module of claim 1 that passes the Wet Leakage Current Test at a voltage of 1000 V as measured by the IEC 61215 procedure after a UV exposure simulation test.

16. The photovoltaic module of claim 1 that passes the Wet Leakage Current Test at a voltage of 1,000 V as measured by IEC 61215 procedure after a humidity simulation test for 1,500 hours.

17. A process for making a photovoltaic module comprising sealing at least one photovoltaic cell between a superstrate sheet and a back sheet comprising a polyester material that does not significantly degrade after prolonged exposure to UV radiation or high humidity.

18. The process of a claim 17 further comprising an encapsulant to seal the superstrate sheet to the back sheet.

19. The process of claim 18 wherein the encapsulant comprises EVA.

20. The process of claim 17 wherein the back sheet comprising a polyester material is a single layer and wherein such layer has a water vapor transmission rate that is less than about 10 grams/meters²/day at 37.8° C. as measured by the ASTM E96 procedure, a dielectric breakdown voltage greater than about 12,000 V as measured by the ASTM D149 procedure using a 0.002 inch thick layer sheet, and a tensile strength of at least about 18,000 psi as measured by the ASTM D882 procedure.

21. The photovoltaic module of claim 2 where the back sheet has a first side and a second side, and has a silicone primer on both the first side and the second side.

22. The photovoltaic module of claim 2 that passes the Wet Leakage Current test at a voltage of 1,000 V as measured by the IEC 612215 procedure after the humidity simulation test of 1,500 hours.

23. The photovoltaic module of claim 2 that passes the Wet Leakage Current Test at a voltage of 1000 V as measured by the IEC 612215 procedure after a UV exposure simulation test.

24. The photovoltaic module of claim 7 that passes the Wet Leakage Current test at a voltage of 1,000 V as measured by the IEC 612215 procedure after the humidity simulation test of 1,500 hours.

25. The photovoltaic module of claim 8 that passes the Wet Leakage Current Test at a voltage of 1,000V as measured by the IEC 612215 procedure after a UV exposure simulation test.

26. The photovoltaic module of claim 7 that passes the Wet Leakage Current test at a voltage of 1,000 V as measured by the IEC 612215 procedure after the humidity simulation test of 1,500 hours.

27. The photovoltaic module of claim 8 that passes the Wet Leakage Current Test at a voltage of 1,000V as measured by the IEC 612215 procedure after a UV exposure simulation test.

28. The photovoltaic module of claim 1 that passes the pull test after the humidity simulation test of 1,500 hours.

29. The photovoltaic module of claim 1 that passes the pull test after the UV exposure simulation test.

30. The photovoltaic module of claim 2 that passes the pull test after the humidity simulation test of 1,500 hours.

31. The photovoltaic module of claim 2 that passes the pull test after the UV exposure simulation test.
